(19) United States
(12) Patent Application Publication
(10) Pub. No.: US 2016/0285630 A1
(43) Pub. Date: Sep. 29, 2016

(54) PRIVATE SERVICE IDENTIFIERS IN NEIGHBORHOOD AWARE NETWORKS

(71) Applicant: QUALCOMM Incorporated, San Diego, CA (US)

(72) Inventors: Santosh Paul ABRAHAM, San Diego, CA (US); Abhishek Pramod PATIL, San Diego, CA (US); Alireza RAISSINIA, Monte Sereno, CA (US); George CHERIAN, San Diego, CA (US); Rolf DE VEGT, San Francisco, CA (US)

(21) Appl. No.: 15/076,487

(22) Filed: Mar. 21, 2016

Related U.S. Application Data
(60) Provisional application No. 62/137,140, filed on Mar. 23, 2015.

(51) Int. Cl. H04L 9/08; H04L 9/14; H04L 9/32; H04L 29/12; H04L 29/06

(52) U.S. Cl. CPC H04L 9/0861; H04L 61/6022; H04L 65/4076; H04L 9/3239; H04L 9/3242; H04L 9/14; H04L 63/08

(57) ABSTRACT

A method, an apparatus, and a computer-readable medium for wireless communication are provided. In an aspect, an apparatus may be configured to generate a first hash value based on a service name associated with a service. The apparatus may be configured to generate a service identifier based on the first hash value, timing information, a password, and a MAC address. The apparatus may be configured to transmit the generated service identifier.

### CROSS-REFERENCE TO RELATED APPLICATION(S)

This application claims the benefit of U.S. Provisional Application Ser. No. 62/137,140, entitled “METHODS AND APPARATUS FOR PRIVATE SERVICE IDENTIFIERS IN NEIGHBORHOOD AWARE NETWORKS” and filed on Mar. 23, 2015, which is expressly incorporated by reference herein in its entirety.

### BACKGROUND

1. Field

The present application relates generally to wireless communications, and more specifically to systems, methods, and devices supporting private service identifiers in a neighbor awareness networking (NAN).

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), a NAN, or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

Devices in a wireless network can transmit and/or receive information to and from each other. To carry out various communications, the wireless devices can coordinate according to a protocol. As such, wireless devices can exchange information to coordinate their activities. Improved systems, methods, and wireless devices for coordinating transmitting and sending communications within a wireless network are desired.

### SUMMARY

The systems, methods, devices, and computer-readable medium discussed herein each have several aspects, no single one of which is solely responsible for its desirable attributes. Without limiting the scope of this invention as expressed by the claims that follow, some features are discussed briefly below. After considering this discussion, and particularly after reading the section entitled “Detailed Description,” it will be understood how advantageous features of this invention include improved efficiency when introducing devices on a medium.

One aspect of this disclosure provides an apparatus (e.g., a station) for wireless communication. The apparatus may be configured to generate a first hash value based on a service name associated with a service. The apparatus may be configured to generate a service identifier based on the first hash value and timing information. The service identifier may be further based on a password and a medium access control address of the apparatus. The apparatus may be configured to transmit the generated service identifier

### BRIEF DESCRIPTION OF THE DRAWINGS

FIG. 1 illustrates an example of a wireless communication system in which aspects of the present disclosure can be employed in accordance with an embodiment.

FIG. 2 is a conceptual diagram for generation of a service identifier (ID) that can be employed in the wireless communication system of FIG. 1 in accordance with an embodiment.

FIG. 3A illustrates a data structure table for which a service ID of FIG. 3 can be utilized in accordance with certain embodiments.

FIG. 3B illustrates a data structure table for which a service control field of FIG. 3A can be utilized in accordance with certain embodiments.

FIG. 4 illustrates a method for generating and transmitting a message with a service ID that includes a hash value of a service name.

FIG. 5 is a flow chart of an exemplary method for transmitting service information in a wireless NAN.

FIG. 6 illustrates a method for generating and receiving a message with a service ID that includes a hash value of a service name.

FIG. 7 illustrates a first method of generating a private service ID.

FIG. 8 illustrates a second method of generating a private service ID.

FIG. 9 illustrates a third method of generating a private service ID.

FIG. 10 shows an example functional block diagram of a wireless device that generates and transmits service IDs within the wireless communication system of FIG. 1.

FIG. 11 is a flow chart of an exemplary method for generating a private service ID.

FIGS. 12A-C are flow charts of an exemplary methods for generating a private service ID.

FIG. 13 is a functional block diagram of an example wireless communication device that provides service IDs.

FIGS. 14A and 14B provide additional detail specific to NAN operations.

FIG. 15 illustrates an exemplary service descriptor attribute.

### DETAILED DESCRIPTION

Various aspects of the novel systems, apparatuses, computer-readable medium, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method that is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices, which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, the station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

Wireless devices, such as a group of STAs, for example, can be used for neighborhood aware networking or social Wi-Fi networking. For example, various stations within the network can communicate on a device to device (e.g., peer-to-peer communications) basis with one another regarding applications that each of the STAs supports. It is desirable for a discovery protocol used in a social Wi-Fi network to enable STAs to advertise themselves (e.g., by sending discovery packets) as well as discover services provided by other STAs (e.g., by sending paging or query packets), while ensuring secure communication and low power consumption. It should be noted that a discovery packet can also be referred to as a discovery message or a discovery frame. It should also be noted that a paging or query packet can also be referred to as a paging or query message or a paging or query frame.

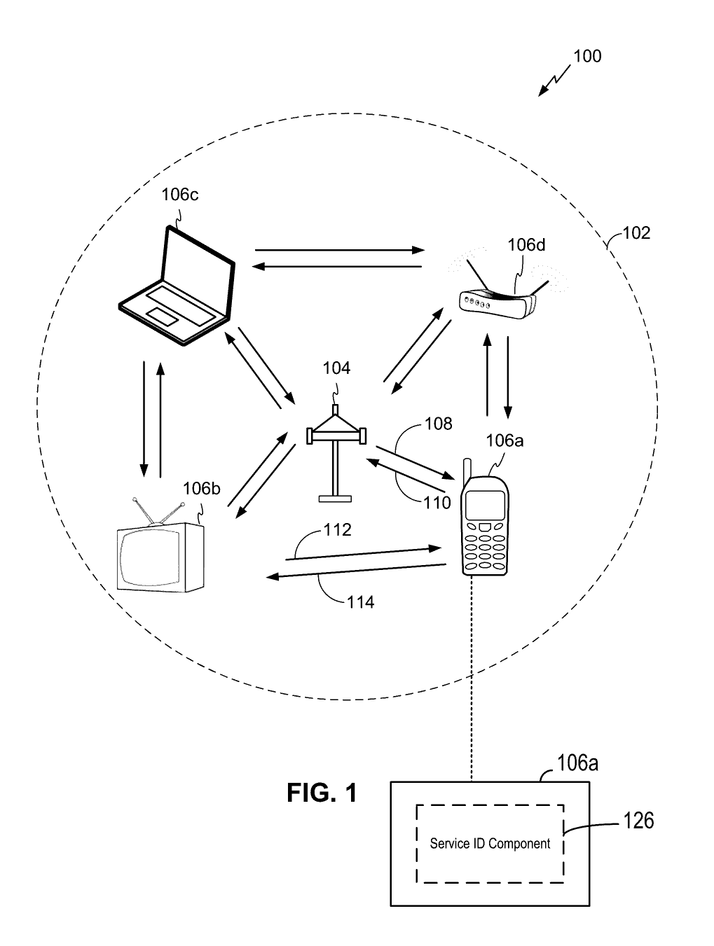

FIG. 1 illustrates an example of a wireless communication system 100 in which aspects of the present disclosure can be employed in accordance with an embodiment. The wireless communication system 100 can operate pursuant to a wireless standard, such as an 802.11 standard. The wireless communication system 100 can include an AP 104, which communicates with STAs 106. In some aspects, the wireless communication system 100 can include more than one AP. Additionally, the STAs 106 can communicate with other STAs 106. As an example, a first STA 106a can communicate with a second STA 106b. As another example, a first STA 106a can communicate with a third STA 106c.

A variety of processes and methods can be used for transmissions in the wireless communication system 100 between the AP 104 and the STAs 106 and between an individual STA, such as the first STA 106a, and another individual STA, such as the second STA 106b. For example, signals can be sent and received in accordance with OFDM/OFDMA techniques. If this is the case, the wireless communication system 100 can be referred to as an OFDM/OFDMA system. Alternatively, signals can be sent and received between the AP 104 and the STAs 106 and between an individual STA, such as the first STA 106a, and another individual STA, such as the second STA 106b, in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

A communication link can be established between STAs, such as during social Wi-Fi networking in a NAN. Some possible communication links between STAs are illustrated in FIG. 1. As an example, a communication link 112 can facilitate transmission from the first STA 106a to the second STA 106b. Another communication link 114 can facilitate transmission from the second STA 106b to the first STA 106a.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP (e.g., the AP 104), but rather can function as a peer-to-peer network between the STAs 106. Accordingly, the functions of the AP 104 described herein can alternatively be performed by one or more of the STAs 106.

In an aspect, the STA 106a may include a service ID component 126. The service ID component 126 may be configured to generate a first hash value based on a service name associated with a service and generate a service identifier based on the first hash value and timing information. The service identifier may be further based on a password and a medium access control address of the STA 106a. The STA 106a may be configured to transmit the generated service identifier.

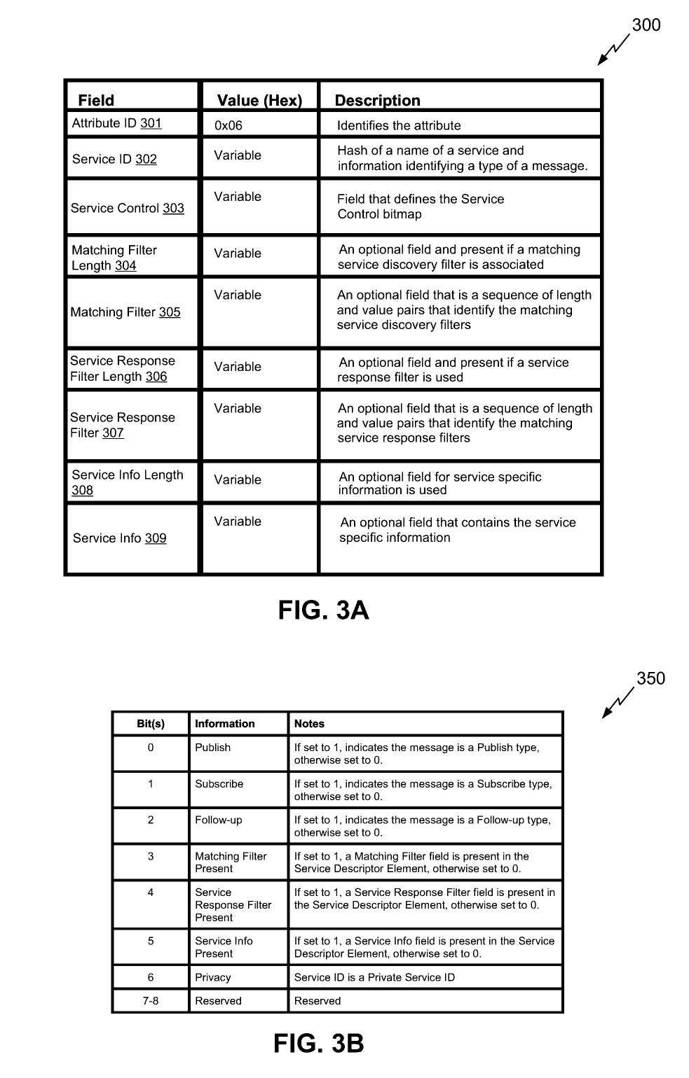

Systems and methods in accordance with various embodiments provide for private service identifiers (IDs) for utilization in wireless devices (such as but not limited to STAs and APs) in NAN networks. A service ID may contain a hash of an input string (e.g., a service name) and may be carried in a service discovery frame (SDF). In a NAN, a service provider may publish the fact that it is providing a service using a publish function. For example, the publish function may be written as: publish(service_name, matching_filter_tx, matching_filter_rx, service_specific_info, configuration_parameters). Similarly, a device searching for a service may attempt to subscribe to the service using a subscribe function. For example, the subscribe function may be written as: subscribe(service_name, matching_filter_rx, matching_filter_tx, service_specific_info, configuration_parameters). A private service ID may include a service ID with additional privacy configuration parameters such that the service ID becomes encrypted. In certain embodiments, a private service ID may be generated as a hash value based on a service name and additional privacy configuration parameters. The additional privacy configuration parameters may be added to either the subscribe function, publish function or both and may include a privacy bit (as discussed further with reference to FIG. 3B) to indicate a private service ID setting and a service ID encryption key (e.g., a password) to encrypt a service name. In some embodiments, the additional privacy configuration parameters may be included in a software application to indicate a private service ID setting. In some aspects, the indication of a private service ID setting in the software application may be separate and independent from the privacy bit indication of a private service ID setting. The hash value may be based on a service name, a service ID encryption key, and/or timing information. Compared with systems that utilize a service ID as a hash value without privacy configuration parameters, systems that utilize a private service ID as a hash value based on a service ID encryption key and/or timing information may enable encryption of the private service ID and may allow for more privacy of a service in a NAN network.

In certain embodiments, wireless devices can provide services that other wireless devices can utilize. These services can be provided by software applications configured to execute on one wireless device while using information generated on another wireless device or information generated for another wireless device, such as but not limited to a game or social networking service. These services can be identified among wireless devices using a service ID within packetized communications among wireless devices. The size of a service ID can be variable, such as but not limited to six bytes.

As discussed above, a service ID encryption key (e.g., a password) and/or timing information can be utilized in generating the hash value to increase the privacy of the service IDs. A service ID generated as a hash value of a service name without privacy configuration parameters may allow third parties to determine which services are being used in an area and the frequency or length of use for a service. Third party monitoring of service use may be undesirable as a service provider or service user may not want their service use monitored. In certain embodiments, the likelihood of undesired third party monitoring of a service may decrease by generating a private service ID as a hash value of a service name, the hash value based on a service ID encryption key and/or timing information.

In certain embodiments, the privacy bit configuration parameter may indicate to a discovery engine to generate a service ID as a hash value based on the service name, the timing information, and/or the service ID encryption key. In other embodiments, a software application may indicate to a discovery engine to generate a service ID as a hash value based on the service name, the timing information, and/or the service ID encryption key. Other values may also be included in the hash computation; such as a cluster ID within the NAN or the current time of day (current UTC value). In certain embodiments, the service ID, which may be carried in a service discovery attribute of a SDF, may be set as follows: service ID=Truncate to 6 bytes of (HASH(service_name, service ID encryption key, timing information). In some embodiments, the timing information may be a portion of a time stamp of the current discovery window (DW) with a number of the least significant bits removed (e.g., last 8, 16, 17 bits). In some embodiments, the timing information may be a time stamp value indicating a start time of the DW. In some embodiments, the timing information may be a time stamp value that is periodically sampled based on the DW. For example, in some aspects, the time stamp value may include the start time of the DW and is sampled every 16^{th}, 8^{th}, 4^{th} 2^{nd}, or every DW. In other aspects, other possible sample periods are possible. In other embodiments, the timing information may be a rolling index or counter that measure the passing of a time interval. In other embodiments, the timing information may be the coordinated universal time (UTC) or other timing system. By basing the service ID in part on the timing information, the service ID may change values as the timing information changes (e.g., every 500 milliseconds) which may provide another layer of privacy because by generating new service IDs at each timing interval, third parties would have to decrypt each private service ID generated to obtain the service name.

In certain embodiments, the hash value may be generated through the utilization or applying of a hash function. A hash function is an algorithm that maps an input string of variable length to a hash value of a fixed length. In some embodiments, the input string may include a service name. Various types of hash functions may be utilized in certain embodiments disclosed herein (e.g., MD5, Secure Hash Algorithm (SHA), cyclic redundancy check (CRC), etc.). In some embodiments, computational limitations may limit the number of times a hash function may be used. For example, if a hash function requires a large of amount of computational power and/or time (e.g., SHA-256), using the hash function every discovery window may become impractical. To overcome some of these limitations, it may be beneficial to use more than one hash function or steps to generate the service ID.

In some embodiments, the discovery engine may use a combination of a high computation (HC) hash and/or a low computation (LC) hash. The LC hash requires lower computational power and/or less time than the HC hash. For example, the discovery engine or processor may compute a first service ID using a HC hash (e.g., SHA-256) as follows: service ID-1=Truncate to 6 bytes of (SHA-256 (service_name)). The discovery engine or processor may then compute a second service ID (and/or each subsequent service ID) using an LC hash (e.g., CRC-64, SHA-3, tiny encryption algorithm (TEA)) based at least in part on the first service ID as follows: service ID-2=Truncate to 6 bytes of (LCHash (ƒ (service ID-1, service ID encryption key, timing information))). In some embodiments, the function ƒ may be a concatenation of the service ID name, encryption key, and/or timing information. In other embodiments, the function ƒ may be a bitwise exclusive OR (XOR), or other bitwise operation, of the timing information (e.g., timestamp), service ID, and/or encryption key.

In embodiments where the discovery engine or processor uses a TEA hash, the hash function may be as follows: tea_code(long*v, long* k), where k is the encryption key to be used and where v is the value to be encrypted. In the TEA algorithm, the value k may be 128 bits. In some aspects, the discovery engine or processor may create the value k from the service ID-1 described above which may require padding to meet the 128 bit requirement. For example, if the service ID-1 is 48 bits, k may be service ID-1 padded with 80 bits of all “0” bits, all “1” bits, or a known combination of “1”s and “0”s. In another example, k may be a concatenation of the service ID-1 such that k=service ID-1|service ID-1|truncate (service ID-1, 4). In some aspects, the discovery engine or processor may create the value v based on the timing information (e.g., timestamp or timing synchronization function) or on the timing information and one or more of a second encryption key, a nonce, a cluster identifier, or a transmitter medium access control (MAC) address. The nonce may be a number that is announced by an anchor master node of the cluster. The discovery engine or processor may create the service ID-2 described above by truncating the result of the TEA algorithm using the computed values of k and v described above to 48 bits. Truncating may be desirable because the TEA algorithm generates a 64 bit result. Using the TEA algorithm may have certain benefits. For example, the TEA may be highly resistant to crypt analysis because it achieves complete diffusion (e.g., 1 bit difference in input causes approximates 32 bit differences in cipher text). Additionally, TEA requires low computation overhead.

Below is a sample code for the TEA algorithm described above:

```
tea_code(long*v, long* k)
  {
  /* long is 4 bytes. */
    unsigned long v0=v[0], v1=v[1];
    unsigned long k0=k[0], k1=k[1], k2=k[2], k3=k[3];
    unsigned long sum=0;
    unsigned long delta = 0x9e3779b9, n=32 ;
    while (n-- >0) {
      sum+= delta ;
      v0 += (v1<<4)+k0 \hat{ } v1+sum \hat{ } (v1>>5)+k1 ;
      v1 += (v0<<4)+k2 \hat{ } v0+sum \hat{ } (v0>>5)+k3 ;
    }
    v[0]=v0 ;
    v[1]=v1 ;
  }
```

Some hash functions and encryption algorithms described herein may have certain data block size requirements. Accordingly, some hash functions and encryption algorithms may require some padding to accommodate the data block size requirements for each function. The padding may be any known (e.g., known by service provider and subscriber) pattern of bits to satisfy the block size requirements. For example, the pattern may comprise all “0” bits, all “1” bits, or a combination of “1”s and “0”s.

A hash function may be referentially transparent, in which a same input string should map to a same hash value. Thereby, vice versa, a same hash value can be indicative of a same input string utilized to generate the same hash value. In certain embodiments, a received service ID as a received hash value can be compared with a reference hash value to determine a name of a service and an anticipated type of message with which the received service ID is associated. As discussed above, this mapping can lead to third parties determining the input string (service name) from a hash value and monitoring of certain services. In some embodiments, when a device receives a private service ID from a service provider via a publish function, the device may wish to subscribe to that service. In some aspects, the discovery engine creates the exact private service ID to be matched based on the hashing function used for the publish function so that the device may subscribe to the service. In some aspects, the discovery engine creates a private service ID to be matched based on the service name used for the publish function so that the device may subscribe to the service.

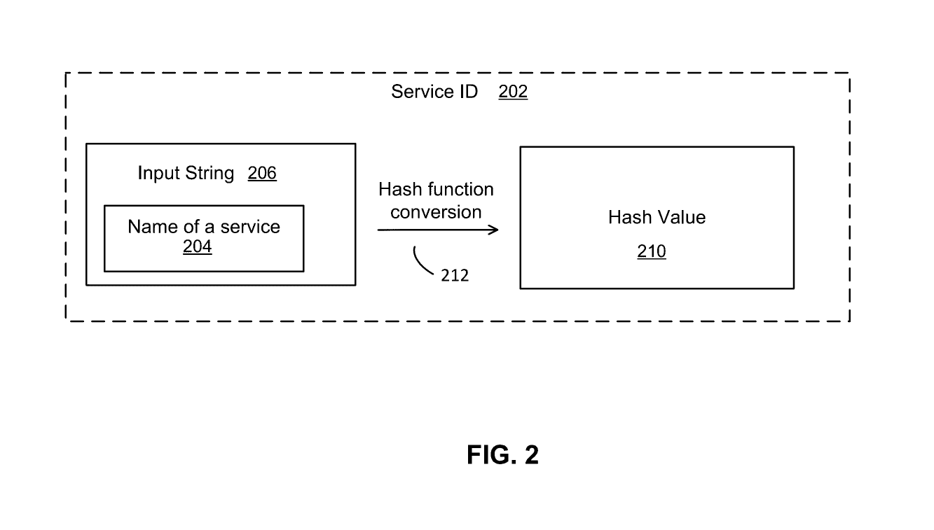

A conceptual diagram for generation of a service ID that can be employed in the wireless communication system of FIG. 1 is illustrated in FIG. 2 in accordance with certain embodiments. The conceptual diagram illustrates that an input string 206 including a name of a service 204 that may be converted to a hash value 210 via a hash function 212. The service ID 202 may be used in packetized communications among wireless devices to identify a service. The service ID may be located in a field of a packet to identify a service, such as (but not limited to) an embodiment illustrated in FIGS. 3A and 3B.

A first data structure in the form of a table for which a service ID 202 of FIG. 2 can be utilized in accordance with certain embodiments is illustrated in FIG. 3A. The table 300 illustrates how different fields of a packet can be communicated among wireless devices in a NAN network concerning an attribute. Any type of attribute can be utilized in accordance with various embodiments, such as but not limited to a service discovery attribute or a service identifier attribute. The packet may include an attribute ID field 301 that identifies the attribute. The size of the field may be one byte and the value of this field may be 0x06 (Hex). The packet may also include a service ID field 302 that may contain a hash of a diversified input string, such as but not limited to a name of a service and information identifying a type of a message. The service ID field 302 may be six bytes and be a variable value. The packet may also include a service control field 303 of one byte with a variable value that defines a service control bitmap. The packet may also include a matching filter length field 304 of one byte and a variable value that is an optional field present if a matching service discovery filter is associated with the attribute. A matching filter field 305 may also be included of a variable size and variable value. The matching filter field 305 can be an optional field that is a sequence of lengths and value pairs that identify the matching service discovery filters. A service response filter length field 306 of one byte and a variable value may be included. The service response filter length field 306 may be an optional field and present if a service response filter is used. A service response filter field 307 of a variable size and variable value may also be utilized. The service response filter field 307 may be a sequence of length and value pairs that identify the matching service response filters. An optional service info length field 308 of one byte and variable value may include service specific information. A service information field 309 of one byte and variable value may contain the service specific information. The various sizes and values discussed herein are exemplary, and other field sizes and values may be applicable.

A second data structure in the form of a table for which a service control field of FIG. 3A can be utilized in accordance with an embodiment is illustrated in FIG. 3B. The table 350 illustrates how different bits of the service control field of FIG. 3A can be communicated to among wireless devices in a NAN network. The service control field may include a bit 0 that indicates whether the message is a publish type. The service control field may also include a bit 1 that indicates whether the message is a subscribe type. The service control field may also include a bit 2 that indicates whether the message is a follow-up type. The service control field may also include a bit 3 that indicates whether a matching filter field is present in a service descriptor element. The service control field may also include a bit 4 that indicates whether a service response filter is present in the service descriptor element. The service control field may also include a bit 5 that indicates whether a service information field is present in the service descriptor element. The service control field may also include a bit 6, the privacy bit, that indicates whether the service ID is a private service ID that is generated based on a service ID encryption key and/or timing information. The service control field may also include bits 7 and 8 that may be reserved for future use.

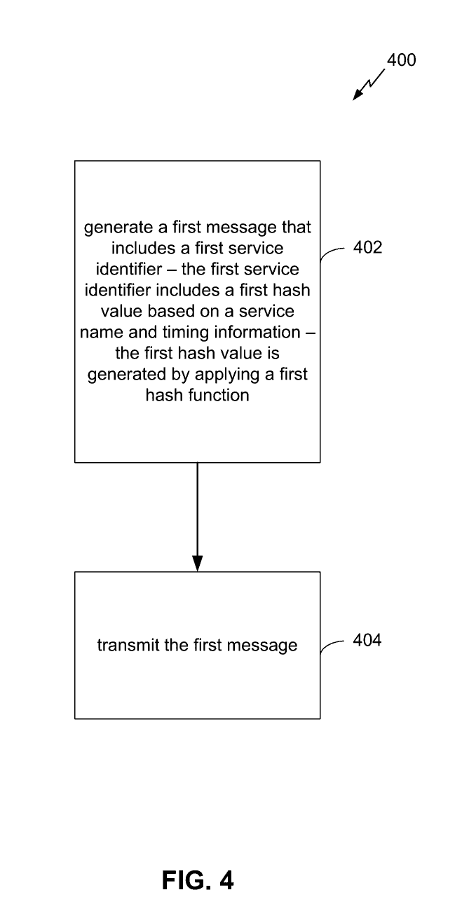

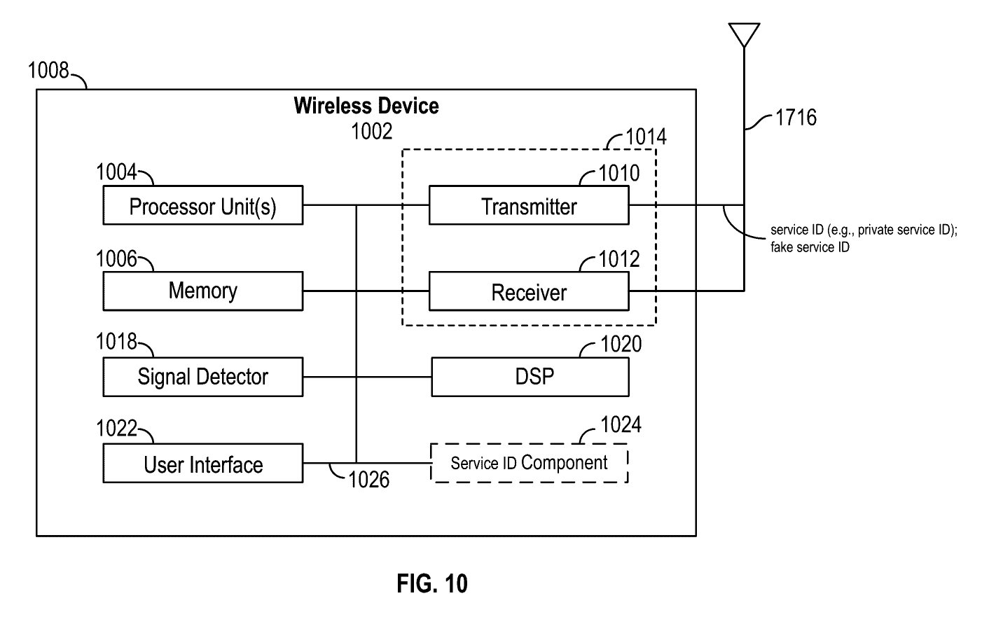

FIG. 4 illustrates a method 400 for generating and transmitting a message with a service ID that includes a hash value of a service name. The hash value may be computed based on an encryption key and/or timing information. In certain embodiments, the method 400 may be performed by a wireless device 1002 in FIG. 10, as described below. Although the method 400 in FIG. 4 is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At block 402, a wireless device may generate a first message that includes a first service identifier. The first service identifier includes a first hash value based on a service name and timing information. The first hash value may be generated by applying a first hash function. At block 404, the first message may then be transmitted from the wireless device. In certain embodiments, the timing information may include a portion of a time stamp value or include a value of a time interval counter.

In some embodiments, a wireless device can perform the method 400 of FIG. 4. In some embodiments, the wireless device can include a means for generating a first message that includes a first service identifier. The first service identifier may include a first hash value based on a service name and timing information, and the first hash value may be generated by applying a first hash function. In certain embodiments, the means for generating the first message can be configured to perform one or more of the functions with respect to block 402 (FIG. 4). In various embodiments, the means for generating the first message can be implemented by a processor 1004 or a digital signal processor (DSP) 1020 (FIG. 10). In some embodiments, the means for generating may include a set of steps performed on a general purpose computer. For example, the computer may receive a request to create a private service ID. The computer may then apply an encryption key and/or timing information to a service ID. The computer may then use a hash function algorithm to generate a hash value of a service name that represents the private service ID based on the encryption key and/or timing information.

The wireless device can further include means for transmitting the first message. In certain embodiments, the means for transmitting can be configured to perform one or more of the functions described above with respect to block 404 (FIG. 4). In various embodiments, the means for transmitting can be implemented by a transmitter 1010 (FIG. 10).

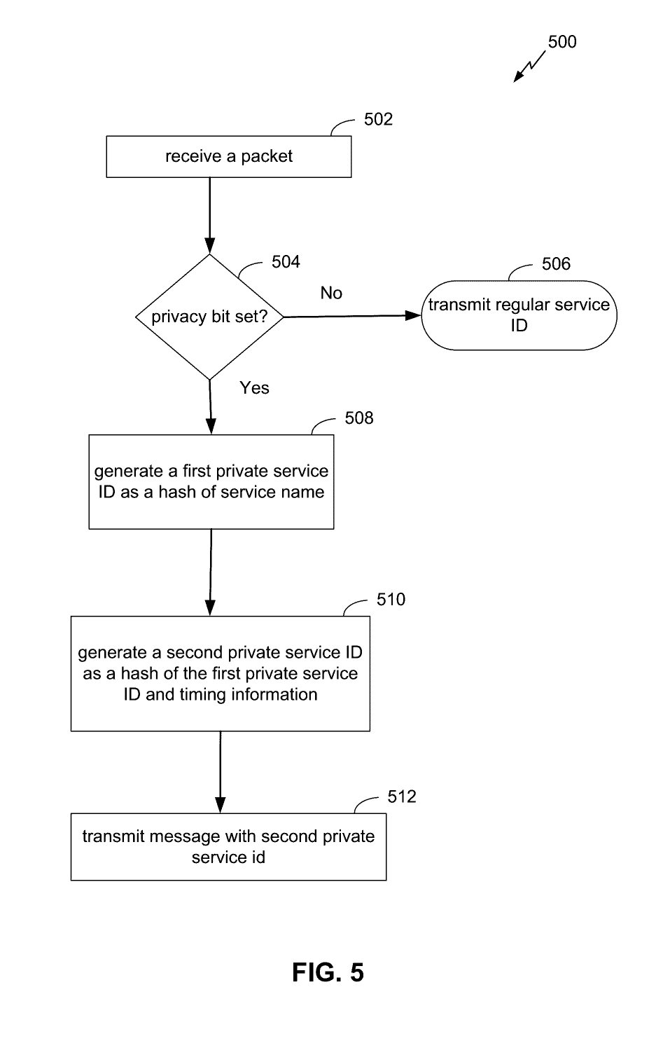

FIG. 5 is a flow chart of an exemplary method 500 for transmitting service information in a wireless NAN. In certain embodiments, the method 500 can be performed by a wireless device 1002 in FIG. 10. Although the method 500 in FIG. 5 is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At block 502, a wireless device may receive a packet. In some embodiments, the packet may include a service discovery frame. At block 504, the wireless device may decode the packet and determine whether a privacy bit in the packet is set. If no, then at block 506, the device may transmit a message with a non-private service ID (e.g., service ID that is not encrypted). If the privacy bit is set, at block 508, the wireless device may generate a first private service ID as a hash of the name of the service. In some embodiments, the wireless device may compute a first service ID using a HC hash (e.g., SHA-256) as discussed above. In some embodiments, the wireless device may transmit the message with the first service ID. At block 510, the wireless device may then compute a second service ID (and/or each subsequent service ID) using an LC hash (e.g., CRC-64, SHA-3, tiny encryption algorithm (TEA)) based at least in part on the first private service ID. For example, the second private service ID may be computed as follows: service ID-2=Truncate to 6 bytes of (LCHash (ƒ (service ID-1, service ID encryption key, timing information). At block 512, the wireless device may transmit a message with the second private service ID. In some embodiments, the message may comprise another service discovery frame. In some aspects, the wireless device may transmit the message with the second service ID after transmitting the message with the first service ID.

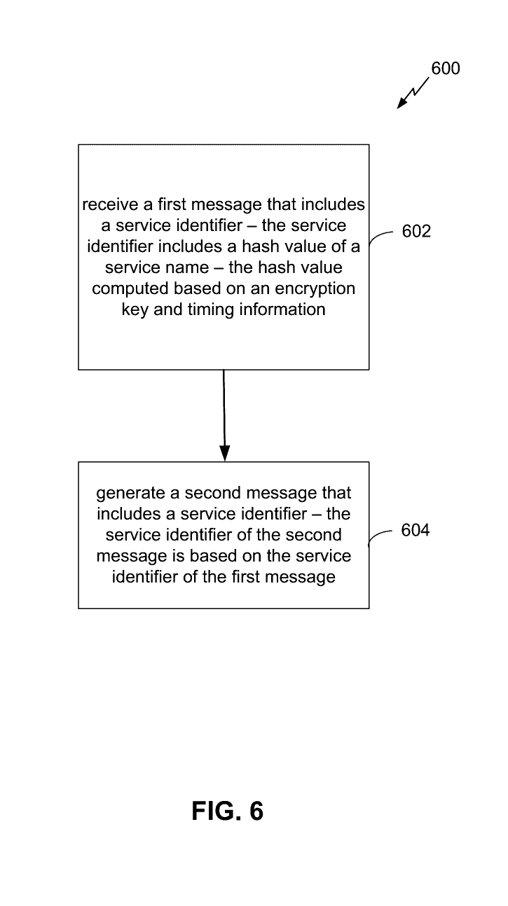

FIG. 6 illustrates a method 600 for generating and receiving a message with a service ID that includes a hash value of a service name. The hash value may be computed based on an encryption key and/or timing information. In certain embodiments, the method 600 can be performed by a wireless device 1002 of FIG. 10. Although the method 600 is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At block 602, a wireless device receives a first message that includes a service identifier. The service identifier may include a hash value of a service name, and the hash value may be computed based on an encryption key and/or timing information. At block 604, the wireless device may generate a second message that includes a service identifier. The service identifier of the second message may be based on the service name of the first message. In certain embodiments, the timing information may include a portion of a time stamp value or comprises a time interval counter.

In some embodiments, a wireless device may be employed to perform a method 600 of FIG. 6 in the wireless communication system of FIG. 1. The wireless device can include a means for receiving a first message, in which the first message includes a service identifier. The service identifier may include a hash value of a service name, and the hash value may be computed based on an encryption key and/or timing information. In certain embodiments, the means for receiving a message may be configured to perform one or more of the functions with respect to block 602 (FIG. 6). In various embodiments, the means for receiving a message can be implemented by a receiver 1012, processor 1004, or DSP 1020 (FIG. 10).

The wireless device may further include means for generating a second message that includes a service identifier. The service identifier of the second message may be based on the service name of the first message. In certain embodiments, the means for generating may be configured to perform one or more of the functions described above with respect to block 604 (FIG. 6). In various embodiments, the means for generating can be implemented by a processor 1004 or DSP 1020 (FIG. 10). In some embodiments, the means for generating may include a set of steps performed on a general purpose computer. For example, the computer may receive a first message that may include a private service ID. The computer may then apply an encryption key and/or timing information to a service ID. The computer may then use a hash function algorithm to generate a hash value of a service name that matches the private service ID of the first message.

To illustrate how certain blocks in FIGS. 4-6 can be implemented, in certain embodiments, a searching wireless device can be configured to search for a service. The searching wireless device can generate a subscribe message (or a subscribe service request message) including a service identifier, the service identifier comprising a hash value of a name of a sought service, the hash value computed based on an encryption key and/or timing information (block 402). The searching wireless device can also transmit the generated message (block 404).

A service providing device can receive a subscribe message (or a subscribe service request message) including the service ID as the hash value of the service name, the hash value computed based on an encryption key and/or timing information (block 602). In some embodiments, the service providing device can generate a publish message (or a publish service announcement message) that includes a service identifier. The service identifier of the second message may be based on the service name of the subscribe message (block 604). In some embodiments, the service providing device may also generate a combination of the publish and the subscribe message to both publish service and subscribe to the service.

When a user or group of users advertises one or more services offered or being used, unintended (e.g., third party) recipients of the advertisements/messages may use the information to monitor the user and/or group of users. For example, the wireless devices of celebrities may advertise service IDs of various services and applications used by the celebrities. Third parties looking to track the celebrities may look for the same service IDs in order to track the celebrities. As such, a need exists to provide people with greater privacy in connection with the applications that are used in wireless devices.

In the event a service ID of a service or application is used to track or to profile someone, users may be protected from trackers that are looking for activity corresponding to a particular service name. In an aspect, the service name associated with the service may be obscured by using a shared password (e.g., a password known only to a group of people). In another aspect, the service ID may be changed on a periodic or aperiodic basis. Service IDs may be further obscured by device IDs (e.g., a MAC address).

In one scenario, given the service name, a sniffer may determine which STAs are currently using a service and determine groups of devices that are part of a service. To make such sniffing more difficult, service names may be changed at different times using an out of band method, in which the “current” name of a service is only known to the required group. In an aspect, a NAN discovery engine (DE) provides a method for a service to specify a “shared key” or a password (e.g., an encryption key) along with the service name. In this aspect, the password may be hashed with the service name to produce the service ID.

In another scenario, a device that is using a service may be tracked over time by simply observing that the same service ID is being sent in service discovery frames SDFs transmitted by the device. To prevent tracking, a service ID for a service may vary in time by incorporating a NAN time stamp when creating the service ID hash. The NAN time stamp may be based on a timing synchronization function.

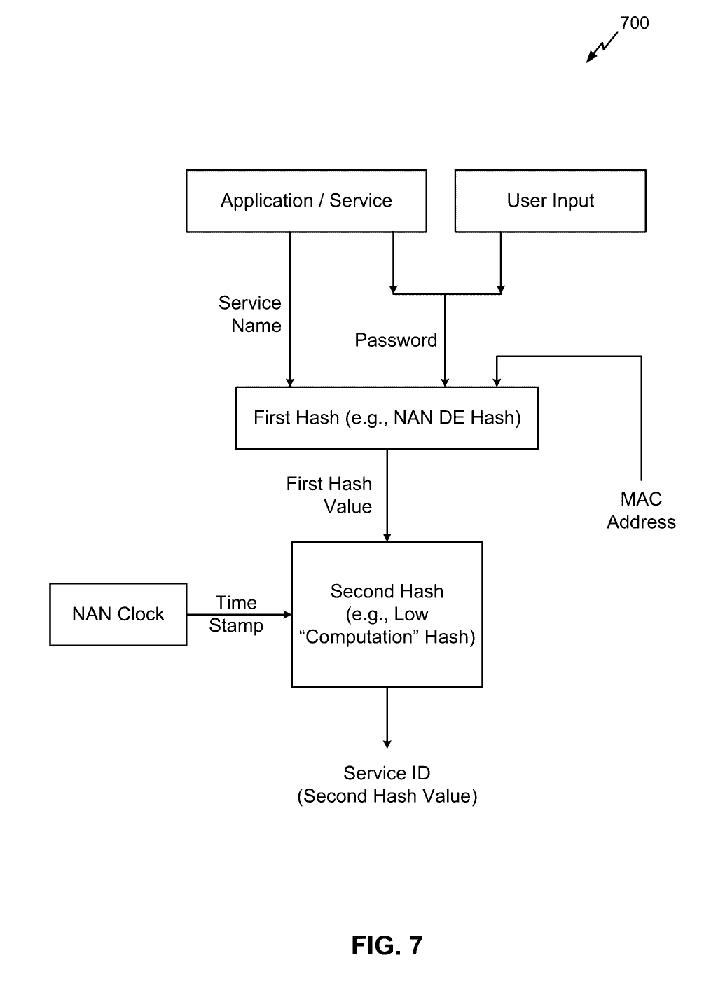

In another scenario, interactions between groups of devices may be tracked by observing that each device within the groups of devices are using the same service IDs. Groups of devices that are interested in the same service may be determined by observing that the groups of devices exchange SDFs containing the same service IDs. To prevent tracking, each device's MAC address may be hashed into the service ID. As such, interactions between devices may not be tied to a common service ID. FIGS. 7-9, below, discuss various methods that may be used for making a service ID more private and less susceptible to tracking/profiling.

FIG. 7 illustrates a first method 700 of generating a private service ID.

Referring to FIG. 7, a user may be using a particular application/service. To launch the service, the user may input a password (e.g., an application password or a group password). In another aspect, the password may already be known to the application or service, and the password may be unique to the user and/or wireless device on which the application is running (e.g., a registered product key). When the service is launched, the service may transmit a service ID to identify/advertise the service to other users that may be nearby. In an aspect, to generate the service ID, the wireless device may generate a first hash value using a first hash function. The first hash function may be applied to a service name associated with the service, the password, and the MAC address of the wireless device (e.g., firsthash(service name, password, MAC address)). The first hash function may be a NAN DE Hash (e.g., a secure hash algorithm, a cyclic redundancy check, or a tiny encryption algorithm). Subsequently, the first hash value and a time stamp based on a NAN clock (e.g., a common clock within a NAN cluster to which all devices in the NAN cluster are synchronized) may be subjected to a second hash function to generate a second hash value. The second hash value may be the service ID. The NAN clock may be a timing synchronization function associated with the NAN. In an aspect, the second hash function may be a low computation hash function, as discussed above, to save on CPU cycles to generate the service ID. After generating the second hash value, which is the service ID, the wireless device may transmit the service ID to other devices (e.g., in a beacon message) within the NAN, for example. In an aspect, this method may be represented by the algorithm service ID=secondhash(firsthash(service name, password, MAC address), time stamp). In an aspect, if a NAN DE SHA-1 hash is used as the first hash function, the wireless device receiving the service ID may be required to compute the SHA-1 hash for every SDF received to decide if there is a match with a service being subscribed/published.

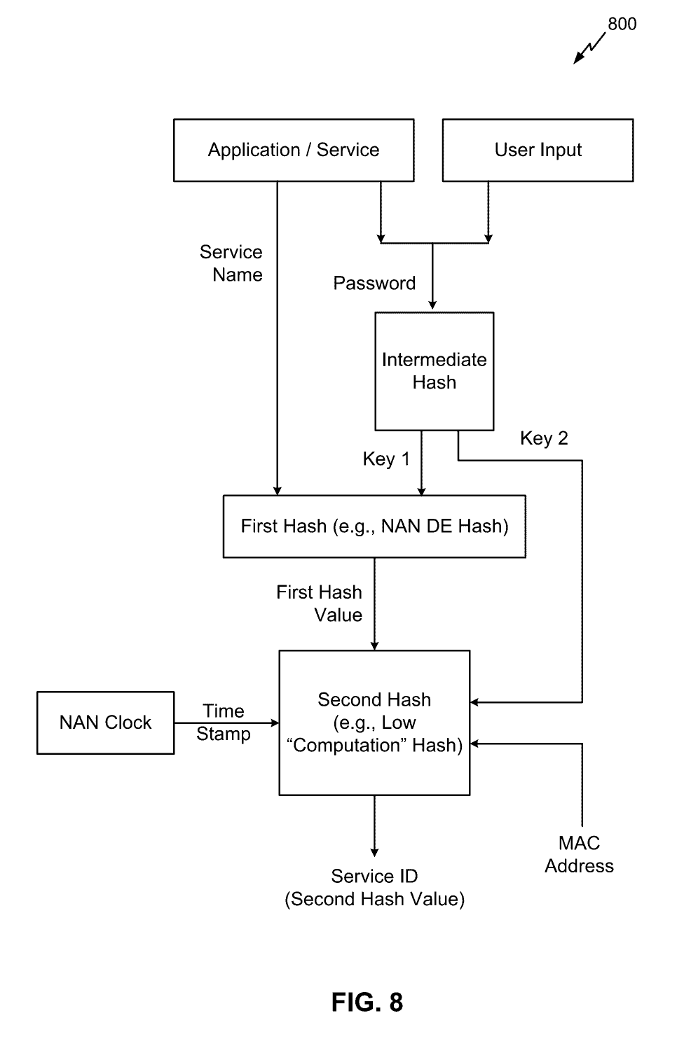

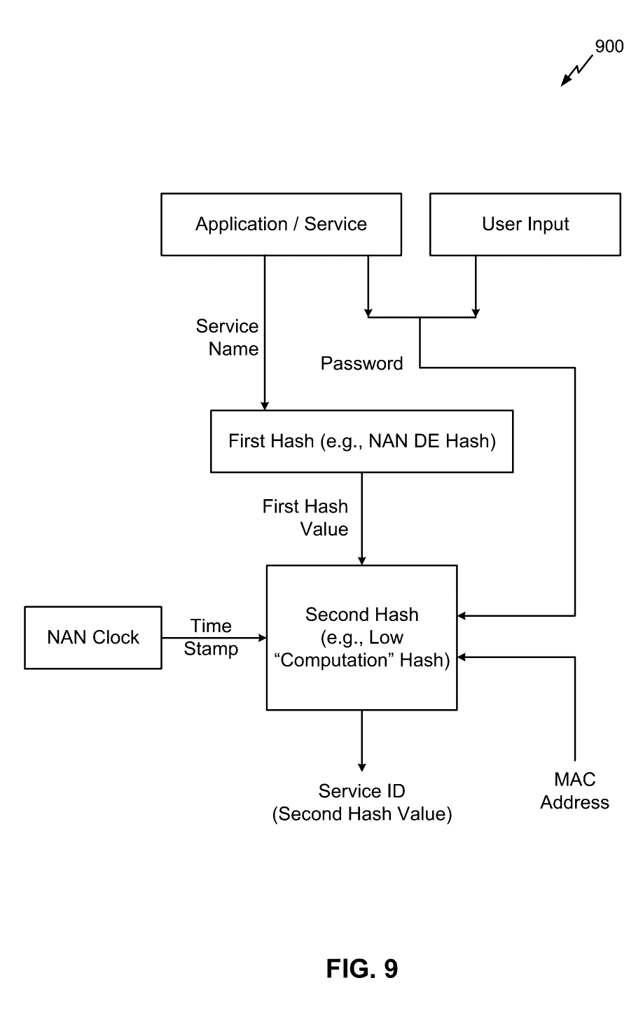

FIG. 8 illustrates a second method 800 of generating a private service ID. Referring to FIG. 8, a user may be using a particular application/service. To launch the service, the user may input a password (e.g., an application password or a group password). In another aspect, the password may already be known to the application or service, and the password may be unique to the user and/or wireless device on which the application is running (e.g., a product key). When the service is launched, the service may transmit a service ID to advertise and/or publish the service. In an aspect, to generate the service ID, the wireless device may generate an intermediate hash value based on the password using an intermediate hash function (e.g., a low computation hash function). The intermediate hash value may be generated by the algorithm intermediatehash(password). The intermediate hash value may be used to derive two keys—key 1 and key 2—as shown in FIG. 9. For example, if the intermediate hash value has 32 bytes, the intermediate hash value may be split into a first 16-byte key (e.g., key 1) and a second 16-byte key (e.g., key 2). Subsequently, a service name associated with the service and key 1 may be subjected to a first hash function to generate a first hash value (e.g., firsthash(service name, key 1)). The first hash function may be a NAN DE hash (e.g., a secure hash algorithm, a cyclic redundancy check, or a tiny encryption algorithm). Subsequently, the first hash value, key 2, a time stamp (e.g., based on a NAN clock), and the MAC address of the wireless device may be subjected to a second hash function (e.g., secondhash(first hash value, key 2, time stamp, MAC address)). The second hash function may be a low computation hash function, which allows the receiver device to quickly compute the matching sequence using a low computation hash. The result of the second hash function, a second hash value, may be the service ID. The wireless device may transmit a message that includes the generated service ID to other devices (e.g., in a beacon message) in the NAN. In an aspect, this method may be represented by the algorithm service ID=secondhash(firsthash(truncatehash1(password), service name), truncatehash2(password), time stamp, MAC address).

FIG. 9 illustrates a third method 900 of generating a private service ID. Referring to FIG. 9, a user may be using a particular application/service. To launch the service, the user may input a password (e.g., an application password or a group password). In another aspect, the password may be already known to the application or service (e.g., a product key), and the password may be unique to the user and/or wireless device on which the application is running. When the service is launched, the service may transmit a service ID. In an aspect, to generate the service ID, the wireless device may generate a first hash value based on a service name associated with the service. The first has value may be generated by applying a first hash function to the service name (e.g., firsthash(service name)). The first hash function may be a NAN DE hash (e.g., a secure hash algorithm, a cyclic redundancy check, or a tiny encryption algorithm). Subsequently, the wireless device may generate the service identifier by applying a second hash function to the first hash value, a time stamp, the password, and a MAC address of the wireless device (e.g., secondhash (first hash value, time stamp, password, MAC address)). The second hash function may be a low computation hash. The wireless device may transmit a message that includes the generated service ID to other devices (e.g., in a beacon message). In an aspect, this method may be represented by the algorithm service ID=secondhash(firsthash(service name), time stamp, password, MAC address).

In another configuration, a wireless device may use a service description attribute that contains a random service ID in an SDF. For example, the wireless device may generate a false/fake message that is not associated with any service published by the wireless device. The false/fake message may include a randomly generated service ID that is not associated with any service related to the wireless device. After generating the false service ID, the wireless device may advertise the false service ID in the false/fake message (e.g., a fake SDA in an SDF). Transmitting fake service IDs may prevent sniffers from being able to map the interaction of devices to any particular service ID.

FIG. 10 shows an example functional block diagram of a wireless device 1002 that generates and transmits service IDs within the wireless communication system 100 of FIG. 1. The wireless device 1002 is an example of a device that may be configured to implement the various methods described herein. For example, the wireless device 1002 may comprise one of the STAs 106.

The wireless device 1002 may include a processor 1004, which controls operation of the wireless device 1002. The processor 1004 may also be referred to as a central processing unit (CPU). Memory 1006, which may include both read-only memory (ROM) and random access memory (RAM), may provide instructions and data to the processor 1004. A portion of the memory 1006 may also include non-volatile random access memory (NVRAM). The processor 1004 typically performs logical and arithmetic operations based on program instructions stored within the memory 1006. The instructions in the memory 1006 may be executable (by the processor 1004, for example) to implement the methods described herein.

The processor 1004 may comprise or be a component of a processing system implemented with one or more processors. The one or more processors may be implemented with any combination of general-purpose microprocessors, microcontrollers, DSPs, field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1002 may also include a housing 1008, and the wireless device 1002 may include a transmitter 1010 and/or a receiver 1012 to allow transmission and reception of data between the wireless device 1002 and a remote device. The transmitter 1010 and the receiver 1012 may be combined into a transceiver 1014. An antenna 1016 may be attached to the housing 1008 and electrically coupled to the transceiver 1014. The wireless device 1002 may also include multiple transmitters, multiple receivers, multiple transceivers, and/or multiple antennas.

The wireless device 1002 may also include a signal detector 1018 that may be used to detect and quantify the level of signals received by the transceiver 1014 or the receiver 1012. The signal detector 1018 may detect such signals as total energy, energy per subcarrier per symbol, power spectral density, and other signals. The wireless device 1002 may also include a digital signal processor (DSP) 1020 for use in processing signals. The DSP 1020 may be configured to generate a packet for transmission. In some aspects, the packet may comprise a physical layer convergence procedure (PLCP) protocol data unit (PPDU).

The wireless device 1002 may further comprise a user interface 1022 in some aspects. The user interface 1022 may comprise a keypad, a microphone, a speaker, and/or a display. The user interface 1022 may include any element or component that conveys information to a user of the wireless device 1002 and/or receives input from the user.

When the wireless device 1002 is implemented as a STA (e.g., the first STA 106a), the wireless device 1002 may also include a service ID component 1024. The service ID component 1024 may be configured to generate a first hash value based on a service name associated with a service. The service ID component 1024 may be configured to generate a service identifier based on the first hash value and timing information. The service identifier may be further based on a password and a MAC address of the wireless device 1002. The service ID component 1024 may be configured to transmit the generated service identifier. In an aspect, the service may be a NAN service, and the transmitted service identifier may enable discovery of the NAN service. In another aspect, the password may be associated with the NAN service, with a group of devices within the NAN, or with a product key. In one configuration, the first hash value may be generated based on the MAC address and the password. In this configuration, the service ID component 1024 may be configured to generate the service identifier by generating a second hash value based on the first hash value and the timing information, in which the second hash value is the service identifier. In another configuration, the service ID component 1024 may be configured to generate the service identifier by generating a second hash value based on the first hash value, the timing information, the MAC address, and the password. In this configuration, the second hash value is the service identifier. In another configuration, the service ID component 1024 may be configured to generate the first hash value by generating an intermediate hash value of the password and by deriving a first key and a second key based on the intermediate hash value of the password. The first hash value may be generated based on the service name and the derived first key. In this configuration, the generated service identifier may be further based on a hash of timing information, the MAC address of the wireless device 1002, the second key derived based on the intermediate hash value, and the first hash value. In another aspect, the first hash value may be generated using a first hash function, and the first hash function may be one of a SHA, a CRC, or a TEA. In another aspect, the service identifier may be generated using a second hash function, and the second hash function may be different from the first hash function. In another configuration, the service ID component 1024 may be configured to transmit a fake service identifier that is not associated with any service related to the wireless device 1002. In an aspect, the fake service identifier may be randomly generated.

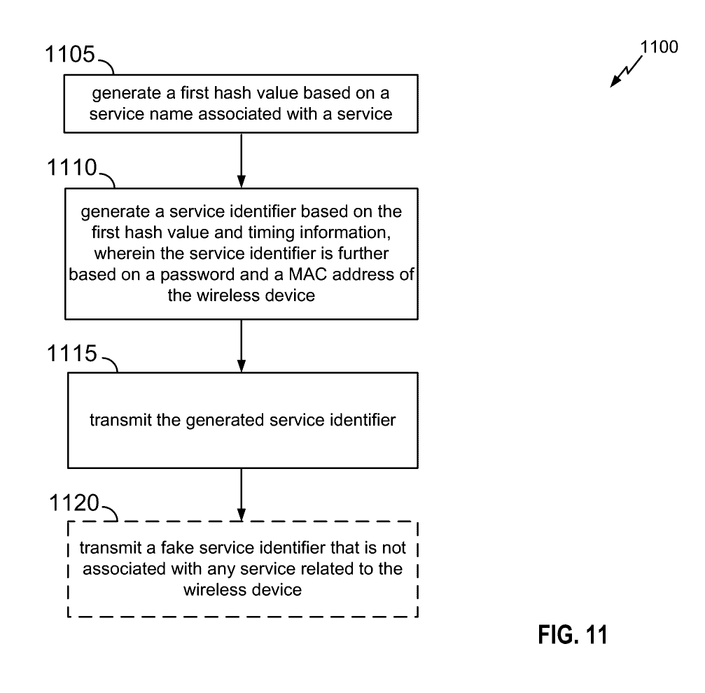

FIG. 11 is a flow chart of an exemplary method 1100 for generating a private service ID. The method 1100 may be performed by an apparatus (e.g., the wireless device 1002). Although the method 1100 is described below with respect to the elements of the wireless device 1002 of FIG. 10, other components may be used to implement one or more steps described herein. Further, although the method 1100 in FIG. 11 is illustrated in a particular order, in certain embodiments, the blocks herein may be performed in a different order, or omitted, and additional blocks can be added.

At block 1105, a wireless device may generate a first hash value based on a service name associated with a service. In an aspect, the service is a NAN service available to wireless devices subscribed to the NAN. In one configuration, the wireless device may generate the first hash value by selecting a hash function, inputting the service name into the hash function, and determining an output of the hash function based on the service name.

At block 1110, the wireless device may generate a service identifier based on the first hash value and timing information. The service identifier may be further based on a password and a MAC address of the wireless device. In an aspect, the password may be associated with the NAN service, with a group of devices within the NAN, or with a product key. In one configuration, the wireless device may generate the service identifier by selecting a second hash function, by inputting the first hash value and the timing information into the second hash function, and by determining an output of the hash function based on the first hash value and the timing information.

At block 1115, the wireless device may transmit the generated service identifier. In an aspect, the transmitted service identifier enables discovery of the NAN service by other wireless devices.

At block 1120, the wireless device may transmit a fake service identifier that is not associated with any service related to the wireless device. The fake service identifier may be randomly generated.

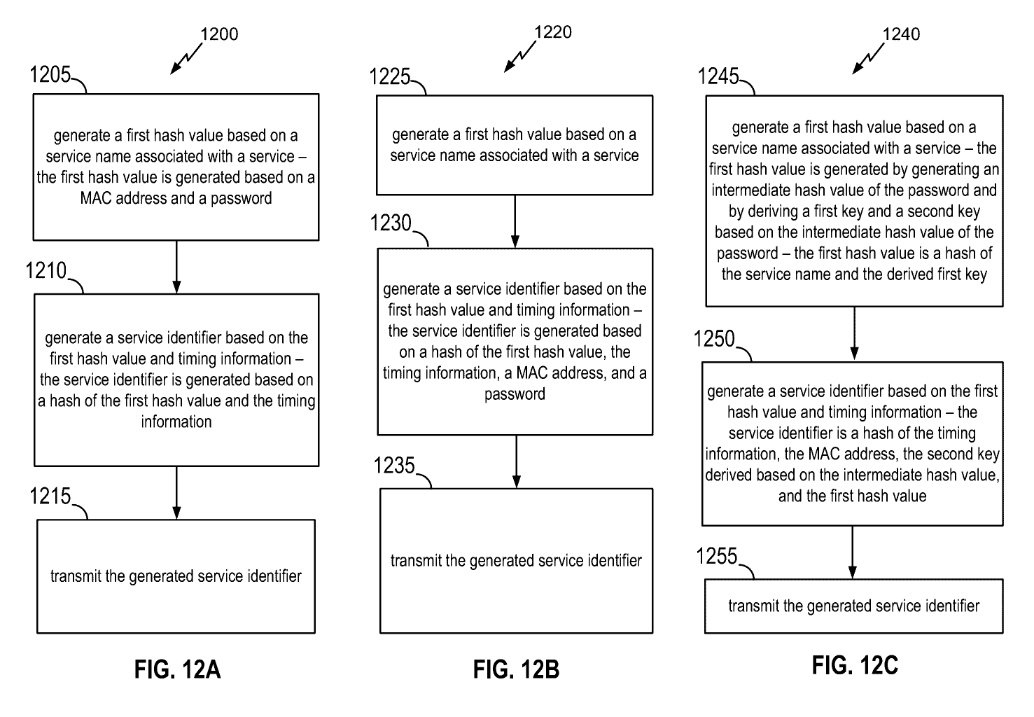

FIGS. 12A-C are flow charts of an exemplary methods 1200, 1200, 1240 for generating a private service ID. The methods 1200, 1220, 1240 may be performed by an apparatus (e.g., the wireless device 1002). Although the method 1200 is described below with respect to the elements of the wireless device 1002 of FIG. 10, other components may be used to implement one or more steps described herein. Further, although the methods 1200, 1220, 1240 in FIG. 12 are illustrated in a particular order, in certain embodiments, the blocks herein may be performed in a different order, or omitted, and additional blocks can be added.

Referring to FIG. 12A, at block 1205, a wireless device may generate a first hash value based on a service name associated with a service. The first hash value may be generated based on a MAC address and a password. For example, the wireless device may generate the first hash value by hashing (e.g., using a SHA) the name of a NAN gaming service, the MAC address of the wireless device, and a password associated with the user's account for the gaming service.

At block 1210, the wireless device may generate a service identifier based on the first hash value and timing information. The service identifier is generated based on a hash of the first hash value and the timing information. For example, the wireless device may generate the service identifier by performing a CRC hash of the first hash value and a NAN clock timestamp.

At block 1215, the wireless device may transmit the generated service identifier to other devices within the NAN.

Referring to FIG. 12B, at block 1225, a wireless device may generate a first hash value based on a service name associated with a service. For example, the wireless device may generate the first hash value by hashing (e.g., using a SHA) the name of a NAN file sharing service.

At block 1230, the wireless device may generate a service identifier based on the first hash value and timing information. The service identifier may be generated based on a hash of the first hash value, the timing information, a MAC address, and a password. For example, the wireless device may generated the service identifier by hashing (e.g., using a TEA) the first hash value, a NAN clock timestamp, the MAC address of the wireless device, and a group password associated with a group of devices within the NAN. As such, devices not associated with the group may not be able to decode the service identifier.

At block 1235, the wireless device may transmit the generated service identifier to other devices within the NAN.

Referring to FIG. 12C, at block 1245, a wireless device may generate a first hash value based on a service name associated with a service. The first hash value may be generated by generating an intermediate hash value of the password and by deriving a first key and a second key based on the intermediate hash value of the password. The first hash value may be a hash of the service name and the derived first key. For example, the wireless device may generate the first hash value by hashing the password associated with a NAN gaming service (e.g., a group password) to create an intermediate hash value. The wireless device may split the intermediate hash value in a first and second key. The first key may be hashed with the NAN gaming service name to generate the first hash value.

At block 1250, the wireless device may generate a service identifier based on the first hash value and timing information. The service identifier may be a hash of the timing information, the MAC address, the second key derived based on the intermediate hash value, and the first hash value. For example, the wireless device may generate the service identifier by hashing (e.g., using a SHA) a NAN clock timestamp, the MAC address of the wireless device, the second key derived based on the intermediate hash value, and the first hash value.

At block 1255, the wireless device may transmit the generated service identifier to other wireless devices in the NAN.

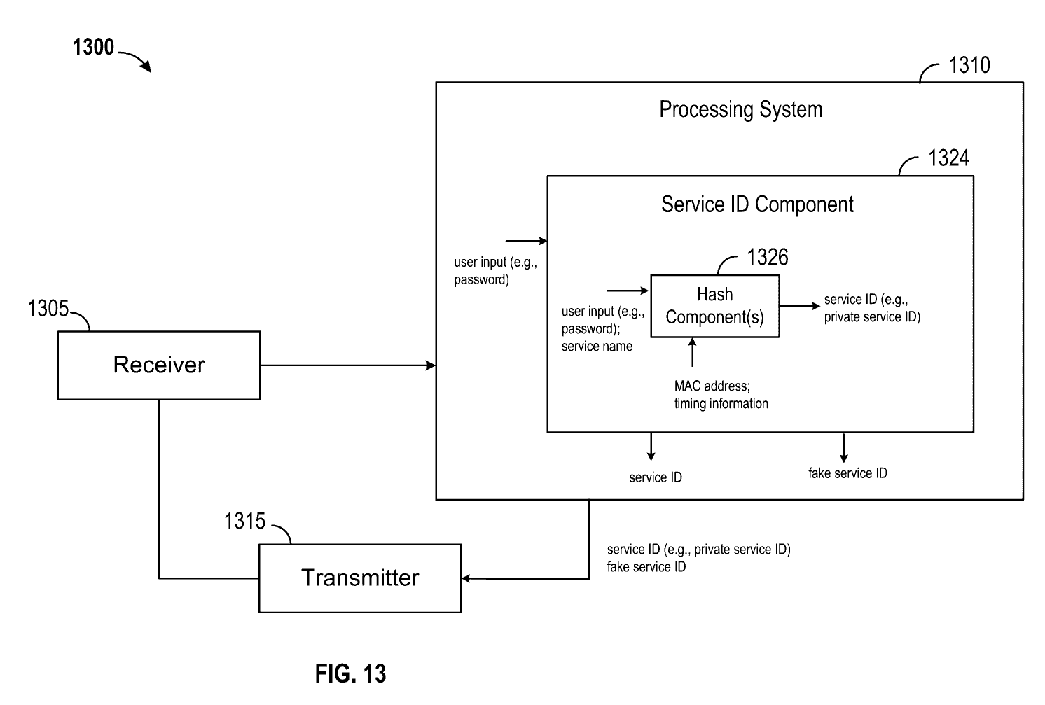

FIG. 13 is a functional block diagram of an example wireless communication device 1300 that provides service IDs. The wireless communication device 1300 may include a receiver 1305, a processing system 1310, and a transmitter 1315. The processing system 1310 may include a service ID component 1324, which may include one or more hash components 1326. The service ID component 1324 and/or the one or more hash components 1326 may generate a first hash value based on a service name associated with a service. The service ID component 1324 and/or the one or more hash components 1326 may generate a service identifier based on the first hash value and timing information. The service identifier may be further based on a password and a MAC address of the wireless communication device 1300. The service ID component 1324, the one or more hash components 1326, and/or the transmitter 1315 may be configured to transmit the generated service identifier. In an aspect, the service may be a NAN service, and the transmitted service identifier may enable discovery of the NAN service. In another aspect, the password may be associated with the NAN service, with a group of devices within the NAN, or with a product key. In another configuration, the first hash value may be generated based on the MAC address and the password. In this configuration, the service ID component 1324 and/or the one or more hash components 1326 may be configured to generate the service identifier by generating a second hash value based on the first hash value and the timing information. In this configuration, the second hash value is the service identifier. In another configuration, the service ID component 1324 and/or the one or more hash components 1326 may be configured to generate the service identifier by generating a second hash value based on the first hash value, the timing information, the MAC address, and the password, in which the second hash value is the service identifier. In another configuration, the service ID component 1324 and/or the one or more hash components 1326 may be configured to generate the first hash value by generating an intermediate hash value of the password and by deriving a first key and a second key based on the intermediate hash value of the password. The first hash value may be generated based on the service name and the derived first key. In this configuration, the generated service identifier may be further based on a hash of the timing information, the MAC address of the wireless communication device 1300, the second key derived based on the intermediate hash value, and the first hash value. In an aspect, the first hash value may be generated using a first hash function. The first hash function may be one of a SHA, a CRC, or a TEA. In another aspect, the service identifier may be generated using a second hash function. The second hash function may be different from the first hash function. In another configuration, the service ID component 1324, the one or more hash components 1326, and/or the transmitter 1315 may be configured to transmit a fake service identifier that is not associated with any service related to the wireless communication device 1300. In this configuration, the fake service identifier may be randomly generated.

The receiver 1305, the processing system 1310, the service ID component 1324, the one or more hash components 1326, and/or the transmitter 1315 may be configured to perform one or more functions discussed above with respect to blocks 402 and 404 of FIG. 4, to blocks 502, 504, 506, 508, 510, and 512 of FIG. 5, to blocks 602 and 604 of FIG. 6, to blocks 1105, 1110, 115, and 1120 of FIG. 11, and to blocks 1205, 1210, 1215, 1225, 1230, 1235, 1245, 1250, and 1255 of FIG. 12. The receiver 1305 may correspond to the receiver 1012. The processing system 1310 may correspond to the processor 1004. The transmitter 1315 may correspond to the transmitter 1010. The service ID component 1324 may correspond to the service ID component 126, and/or the service ID component 1024.

In one configuration, the wireless communication device 1300 may include means for generating a first hash value based on a service name associated with a service. The wireless communication device 1300 may include means for generating a service identifier based on the first hash value and timing information. The service identifier may be further based on a password and a MAC address of the wireless communication device 1300. The wireless communication device 1300 may include means for transmitting the generated service identifier. In an aspect, the service may be a NAN service, and the transmitted service identifier may enable discovery of the NAN service. In another aspect, the password may be associated with the NAN service, with a group of devices within the NAN, or with a product key. In another configuration, the first hash value may be generated based on the MAC address and the password. In this configuration, the means for generating the service identifier may be configured to generate a second hash value based on the first hash value and the timing information. In this configuration, the second hash value is the service identifier. In another configuration, the means for generating the service identifier may be configured to generate a second hash value based on the first hash value, the timing information, the MAC address, and the password. The second hash value may be the service identifier. In another configuration, the means for generating the first hash value may be configured to generate an intermediate hash value of the password and to derive a first key and a second key based on the intermediate hash value of the password. The first hash value may be generated based on the service name and the derived first key. In another configuration, the generated service identifier may be further based on a hash of the timing information, the MAC address of the wireless device, the second key derived based on the intermediate hash value, and the first hash value. In an aspect, the first hash value may be generated using a first hash function. The first hash function may be one of a SHA, a CRC, or a TEA. In another aspect, the service identifier may be generated using a second hash function, and the second hash function may be different from the first hash function. In another aspect, the wireless communication device 1300 may include means for transmitting a fake service identifier that is not associated with any service related to the wireless communication device 1300. In this aspect, the fake service identifier may be randomly generated.

For example, means for generating the first hash value may include the service ID component 1324 and/or the one or more hash components 1326. Means for generating a service identifier may include the service ID component 1324 and/or the one or more hash components 1326. Means for transmitting the generated service identifier may include the service ID component 1324 and/or the transmitter 1315. Means for transmitting a fake service identifier may include the service ID component 1324 and/or the transmitter 1315.

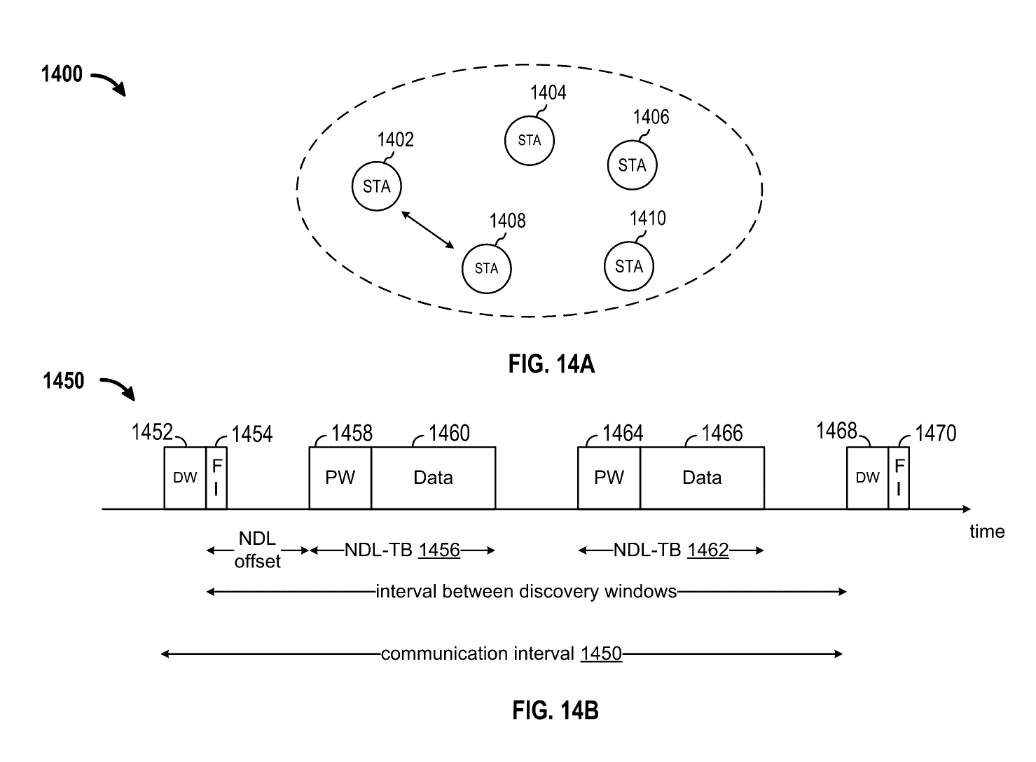

As described above, private service IDs may be utilized in NAN to provide users greater privacy when using a NAN service. FIGS. 14A and 14B provide additional detail specific to NAN operations. NAN provides a mechanism for devices to synchronize time and channel on which the devices may converge to facilitate the discovery of NAN services that have been made discoverable on existing or new devices that enter the NAN. In an aspect, the service discovery may occur without the assistance of an AP. A NAN network may operate in only one channel in the 2.4 gigahertz (GHz) frequency band, and optionally, in one channel in the 5 GHz frequency band. The NAN channel in the 2.4 GHz frequency band may be channel 6 (2.327 GHz).

A NAN network may include one or more NAN clusters. FIG. 14A is an exemplary diagram 1400 of a NAN cluster. A NAN cluster may include multiple wireless devices, such as STAs 1402, 1404, 1406, 1408, 1410 (or the STAs 106a, 106b, 106c, 106d). The NAN cluster may be a collection of NAN devices that share a common set of NAN parameters. NAN parameters may include a time period between consecutive discovery windows, the time duration of the discovery windows, and a beacon interval. In an aspect, all of the STAs 1402, 1404, 1406, 1408, 1410 participating in the NAN cluster may be synchronized to the same NAN clock, which may be determined by the STA 1402, for example, if the STA 1402 is acting in the anchor master role of the NAN cluster. The STA 1402, as the anchor master, may determine the timing synchronization function (TSF) and broadcast the TSF in the NAN synchronization beacon. Other STAs in the NAN cluster may be required to adopt the TSF and to broadcast the TSF to other devices within the NAN. The NAN synchronization beacon may be broadcasted by NAN devices during the discovery window. NAN devices that receive the NAN synchronization beacon may use the beacon for clock synchronization. In another aspect, each wireless device within the NAN cluster may communicate with another wireless device via a device-to-device (D2D) connection. For example, the STA 1402 may communicate with the STA 1408 via a D2D connection.

FIG. 14B is an exemplary diagram of a communication interval 1450 in a NAN. The communication interval 1450 may include discovery windows 1452, 1468 (e.g., NAN service discovery windows), which may be time windows designated for and dedicated for enabling wireless devices (e.g., a STA) within a NAN to discover other peer wireless devices. That is, during the discovery window 1452, for example, wireless devices in the NAN may transmit peer discovery signals, such as NAN service discovery frames, for peer discovery. The discovery window 1452 may represent a time period and channel on which the wireless devices in the NAN converge for peer discovery. The time interval between two discovery windows may be 512 time units (e.g., 512 ms). The communication interval 1450 may include fixed intervals 1454 allocated for connection setup. For example, after wireless devices discover each other during the discovery window 1452, the wireless devices may utilize the fixed interval 1454 after the discovery window 1452 to transmit signaling for a connection setup (e.g., a D2D connection setup). In one aspect, the fixed interval 1454 may immediately follow the discovery window 1452 and may be dedicated for connection setup. In another aspect, the fixed interval 1454 may follow the discovery window 1452, but need not immediately follow the discovery window 1452.

In an aspect, wireless devices may perform connection setup during the fixed intervals 1454, 1470. Wireless devices that publish/subscribe to a service may remain awake after the discovery windows 1452, 1468 to exchange connection setup messages in the fixed intervals 1454, 1470. In another aspect, wireless devices may perform connection setup during a data link time block (DL-TB) (or another type of DL-TB) in addition to during the fixed intervals 1454, 1470. As shown in FIG. 14B, the communication interval 1450 includes a first NAN data link (NDL) time block (NDL-TB) 1456 and a second NDL-TB 1462. The first NDL-TB 1456 may be offset from the end or beginning of the discovery window 1452 by an NDL offset value. The first NDL-TB 1456 may include a first paging window 1458 and a first data window 1460. The first paging window 1458 may be used by a first wireless device for paging a second wireless device to indicate that the first wireless device has data to transmit to the second wireless device (e.g., data related to a photo sharing service). Subsequently, the first wireless device may transmit the data in the first data window 1460 used for transmitting data associated with destinations/wireless devices identified during the first paging window 1458. Similarly, the second NDL-TB 1462 may include a second paging window 1464 and a second data window 1466. In another aspect, if the second wireless device is not paged during a paging window (e.g., no data is expected for the second wireless device), then the second wireless device may enter a sleep or doze state.

In an aspect, a third wireless device may have discovered the first wireless device during a previous discovery window and may be aware that the first wireless device is providing a service (e.g., photo sharing service). Subsequently, the third wireless device may want to establish a connection with the first wireless device to receive the service, but the fixed interval 1454 may already have passed. In this aspect, the third wireless device may utilize the first paging window 1458 for connection setup.

During connection setup, NAN devices may establish a schedule for communications, which may be known as an NDL. In one aspect, there may be only one NDL between two NAN devices. A single NDL, however, may support multiple NAN data paths (NDPs) between the two NAN devices. Each NDP may be associated with a different service (e.g., gaming service, photo sharing service, video streaming service, etc.). In an aspect, each NDP may have its own quality of service and/or security requirements. In another aspect, each NDP may have its own interface. As between the two NAN devices, all of the NDPs between the two NAN devices may conform to the same schedule, which may be the NDL schedule between the two STAs.

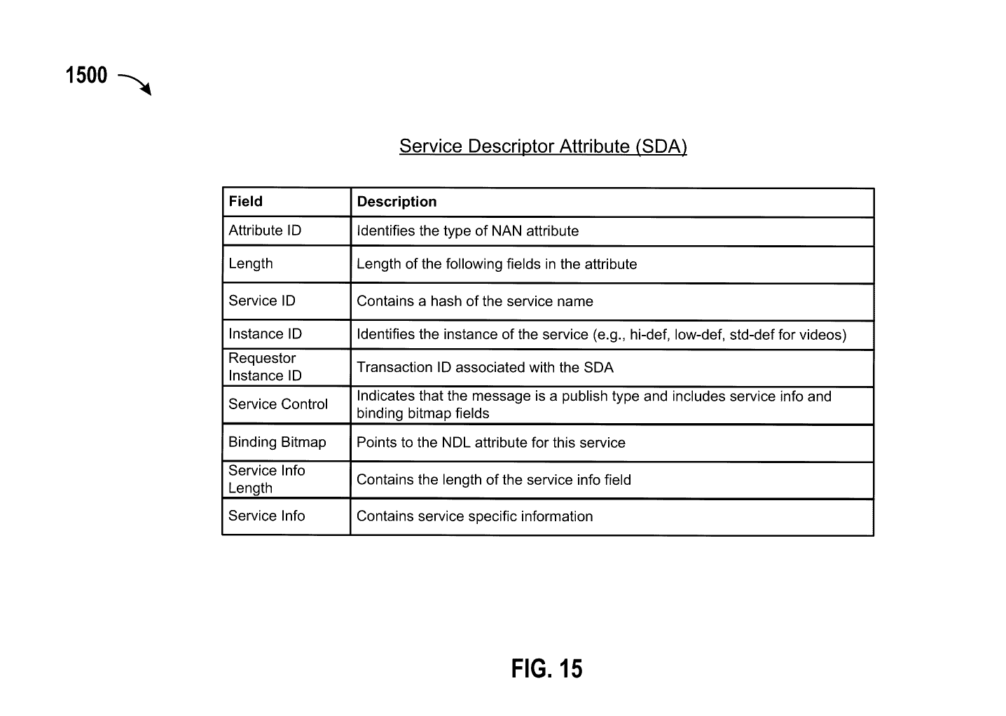

FIG. 15 illustrates an exemplary service descriptor attribute 1500. Referring to FIG. 15, the service descriptor attribute 1500 may be transmitted by a NAN device within a NAN service discovery frame to announce the availability of the service. The service descriptor attribute 1500 may include attribute ID, length, service ID, instance ID, requestor instance ID, service control, binding bitmap, service info length, and service info fields. The attribute ID may be 1 octet in size and may have a value of 0x03. The attribute ID may identify the attribute as a service descriptor attribute, as opposed to other NAN attributes. The length field (e.g., 2 octets in size) may indicate the length of the following fields in the service descriptor attribute 1500. The service ID field (e.g., 6 octets in size) may include a hash of the service name associated with the service descriptor attribute 1500. The service ID field may include the private service ID as described herein. The instance ID (e.g., 1 octet in size) may identify an instance of the service. For example, if the service is video streaming, the instance ID may indicate whether the instance of the service is hi-definition, low-definition, or standard definition video streaming. The requestor instance ID (e.g., 1 octet in size and 0x00 in value) may indicate a transaction ID associated with the service descriptor attribute 1500. The service control field (e.g., 1 octet in size and 0x0A in value) may indicate that the service descriptor attribute 1500 includes the binding bitmap field and the service info field. The binding bitmap field (e.g., 2 octets in size) may be a bitmap that points to an NDL attribute, which may be an attribute that includes the NDL schedule for D2D communications and a service ID associated with the NDL attribute. For example, if the service descriptor attribute 1500 is transmitted in a service discovery frame with multiples attributes, the first of which is the service descriptor attribute 1500 and the second of which is the NDL attribute, the binding bitmap may point to the NDL attribute based on a position of the bit. For example, if there are four attributes, the bitmap may indicate 0100 to indicate that the second attribute is the NDL attribute associated with the service descriptor attribute 1500. The service info length field (e.g., 1 octet in size) may indicate the length of the service info field. The service info field, which may be of variable size, may information specific to the service.

In another aspect, the service ID may also be transmitted in other attributes (e.g., in an NDL attribute) and in other frame other than service discovery frames.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a wireless device, comprising:
generating a first hash value based on a service name associated with a service;
generating a service identifier based on the first hash value, timing information, a password, and a medium access control (MAC) address of the wireless device; and
transmitting the generated service identifier.

2. The method of claim 1, wherein the service is a neighbor awareness networking (NAN) service, and the transmitted service identifier enables discovery of the NAN service.

3. The method of claim 2, wherein the password is associated with the NAN service, with a group of devices within a NAN, or with a product key.

4. The method of claim 2, wherein the transmitting the service identifier comprises broadcasting the service identifier in a NAN service discovery frame during a NAN discovery window.

5. The method of claim 4, wherein the NAN service discovery frame includes a service descriptor attribute and a NAN data link attribute.

6. The method of claim 2, wherein the wireless device is a member of a NAN cluster and shares a common set of NAN parameters with all other members of the NAN cluster associated with the NAN service.

7. The method of claim 6, wherein the wireless device is time synchronized with all the other members of the NAN cluster based on a timing synchronization function determined by an anchor master of the NAN cluster.

8. The method of claim 1, wherein the first hash value is generated based on the MAC address and the password.

9. The method of claim 8, wherein the generating the service identifier comprises generating a second hash value based on the first hash value and the timing information, and wherein the second hash value is the service identifier.

10. The method of claim 1, wherein the generating the service identifier comprises generating a second hash value based on the first hash value, the timing information, the MAC address, and the password, and wherein the second hash value is the service identifier.

11. The method of claim 1, wherein the generating the first hash value comprises:
generating an intermediate hash value of the password; and
deriving a first key and a second key based on the intermediate hash value of the password, wherein the first hash value is generated based on the service name and the derived first key.

12. The method of claim 11, wherein the generated service identifier is further based on a hash of the timing information, the MAC address of the wireless device, the second key derived based on the intermediate hash value, and the first hash value.

13. The method of claim 1, wherein the first hash value is generated using a first hash function, the first hash function being one of a secure hash algorithm (SHA), a cyclic redundancy check (CRC), or a tiny encryption algorithm (TEA).

14. The method of claim 13, wherein the service identifier is generated using a second hash function, the second hash function being different from the first hash function.

15. The method of claim 1, further comprising transmitting a fake service identifier that is not associated with any service related to the wireless device.

16. The method of claim 15, wherein the fake service identifier is randomly generated.

17. An apparatus for wireless communication, comprising:
means for generating a first hash value based on a service name associated with a service;
means for generating a service identifier based on the first hash value, timing information, a password, and a medium access control (MAC) address of the apparatus; and
means for transmitting the generated service identifier.

18. The apparatus of claim 17, wherein the service is a neighbor awareness networking (NAN) service, and the transmitted service identifier enables discovery of the NAN service.

19. The apparatus of claim 18, wherein the password is associated with the NAN service, with a group of devices within a NAN, or with a product key.

20. The apparatus of claim 17, wherein the first hash value is generated based on the MAC address and the password.

21. The apparatus of claim 20, wherein the means for generating the service identifier is configured to generate a second hash value based on the first hash value and the timing information, and wherein the second hash value is the service identifier.

22. The apparatus of claim 17, wherein the means for generating the service identifier is configured to generate a second hash value based on the first hash value, the timing information, the MAC address, and the password, and wherein the second hash value is the service identifier.

23. The apparatus of claim 17, wherein the means for generating the first hash value is configured to:
generate an intermediate hash value of the password; and
derive a first key and a second key based on the intermediate hash value of the password, wherein the first hash value is generated based on the service name and the derived first key.

24. The apparatus of claim 23, wherein the generated service identifier is further based on a hash of the timing information, the MAC address of the apparatus, the second key derived based on the intermediate hash value, and the first hash value.

25. The apparatus of claim 17, wherein the first hash value is generated using a first hash function, the first hash function being one of a secure hash algorithm (SHA), a cyclic redundancy check (CRC), or a tiny encryption algorithm (TEA).

26. The apparatus of claim 25, wherein the service identifier is generated using a second hash function, the second hash function being different from the first hash function.

27. The apparatus of claim 17, further comprising means for transmitting a fake service identifier that is not associated with any service related to the apparatus.

28. The apparatus of claim 27, wherein the fake service identifier is randomly generated.

29. An apparatus for wireless communication, comprising:
a memory; and
at least one processor coupled to the memory and configured to:
generate a first hash value based on a service name associated with a service;
generate a service identifier based on the first hash value, timing information, a password, and a medium access control (MAC) address of the apparatus; and
transmit the generated service identifier.

30. The apparatus of claim 29, wherein the service is a neighbor awareness networking (NAN) service, and the transmitted service identifier enables discovery of the NAN service.

31. The apparatus of claim 30, wherein the password is associated with the NAN service, with a group of devices within a NAN, or with a product key.

32. The apparatus of claim 29, wherein the first hash value is generated based on the MAC address and the password.

33. The apparatus of claim 32, wherein the at least one processor is configured to generate the service identifier by generating a second hash value based on the first hash value and the timing information, and wherein the second hash value is the service identifier.

34. The apparatus of claim 29, wherein the at least one processor is configured to generate the service identifier by generating a second hash value based on the first hash value, the timing information, the MAC address, and the password, and wherein the second hash value is the service identifier.

35. The apparatus of claim 29, wherein the at least one processor is configured to generate the first hash value by:
generating an intermediate hash value of the password; and
deriving a first key and a second key based on the intermediate hash value of the password, wherein the first hash value is generated based on the service name and the derived first key.

36. The apparatus of claim 35, wherein the generated service identifier is further based on a hash of the timing information, the MAC address of the apparatus, the second key derived based on the intermediate hash value, and the first hash value.

37. The apparatus of claim 29, wherein the first hash value is generated using a first hash function, the first hash function being one of a secure hash algorithm (SHA), a cyclic redundancy check (CRC), or a tiny encryption algorithm (TEA).

38. The apparatus of claim 37, wherein the service identifier is generated using a second hash function, the second hash function being different from the first hash function.

39. The apparatus of claim 29, wherein the at least one processor is further configured to transmit a fake service identifier that is not associated with any service related to the apparatus.

40. The apparatus of claim 39, wherein the fake service identifier is randomly generated.

41. A computer-readable medium of a wireless device storing computer executable code, comprising code to:
generate a first hash value based on a service name associated with a service;
generate a service identifier based on the first hash value, timing information, a password, and a medium access control (MAC) address of the wireless device; and
transmit the generated service identifier.
